(19) United States
(12) Patent Application Publication
(10) Pub. No.: US 2026/0288203 A1
(43) Pub. Date: Sep. 24, 2026

(54) VEHICLE HUMAN-MACHINE INTERFACE

(71) Applicant: Ford Global Technologies, LLC, Dearborn, MI (US)

(72) Inventors: Alex Michael Kwan, Redondo Beach, CA (US); Bradford Zercoe, San Jose, CA (US)

(73) Assignee: Ford Global Technologies, LLC, Dearborn, MI (US)

(21) Appl. No.: 19/085,070

(22) Filed: Mar. 20, 2025

(51) Int. Cl. G06F 1/16

(52) U.S. Cl. CPC G06F 1/1632

(57) ABSTRACT

An assembly includes a dock in a vehicle and a portable electronic device. One of the dock or the portable electronic device includes a first casing, and the other of the dock or the portable electronic device includes a second casing. One of the casings defines a notch and the other of the casings includes a finger extending along an axis into the notch in an engaged position. A pin is housed by the first casing and is moveable relative to the first casing between a retracted and an extended position. The pin in the retracted position is disengaged from the second casing allowing movement of the finger along the axis to disengage the first casing and the second casing. The pin in the extended position is engaged with the second casing preventing movement of the finger along the axis to retain the portable electronic device to the dock.

### BACKGROUND

Many modern vehicles are equipped with electronic displays. Sometimes referred to as a digital dash, an electronic gauge cluster includes a set of vehicle instrumentation that may be displayed with a configurable digital readout or display panel, rather than with traditional analog gauges. Due to the configurable nature of the digital displays, electronic gauge cluster may be controlled by the user to display different elements of vehicle information.

### BRIEF DESCRIPTION OF THE DRAWINGS

FIG. 1 is a cutaway view of a vehicle showing an interior of the vehicle.

FIG. 2 is a schematic block diagram of a system of the vehicle.

FIG. 3 is a perspective view of an interior of the vehicle with a personal electronic device and a dock.

FIG. 4A is a cross-section of the dock through line 4 in FIG. 3.

FIG. 4B is a cross-section of the dock and the personal electronic device connected to the dock with a pin of the personal electronic device in a retracted position.

FIG. 4C is a cross-section of the dock and the personal electronic device connected to the dock with a pin of the personal electronic device in an extended position.

FIG. 5 is a cross-section of another example of the dock and the personal electronic device connected to the dock with the pin in an extended position.

### DETAILED DESCRIPTION

A human-machine interface (HMI) of a vehicle may support one or more portable electronic devices that are modular and may be selectively connected and disconnected from the HMI by a user. These portable electronic devices may include a variety of displays and input interfaces such as touch screens, buttons, knobs, or other physical controls. The portable electronic devices may be connected to the vehicle and assigned to various functions. Once connected and configured, the physical controls of the portable electronic devices may offer quick, customized access to the configured functions.

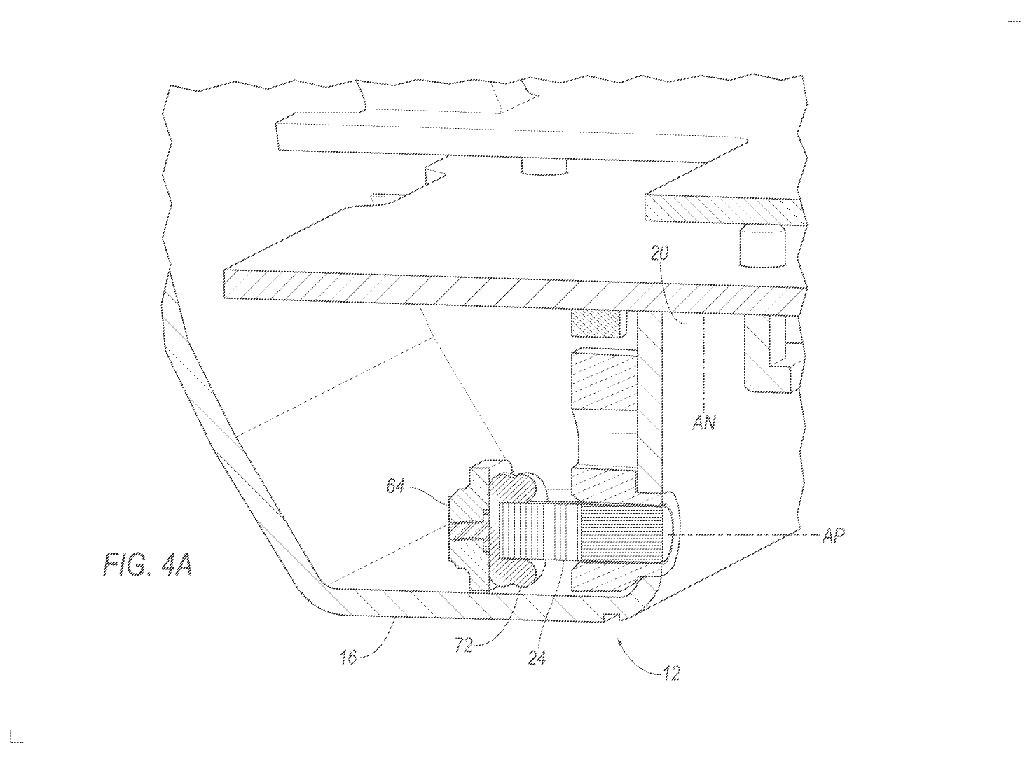

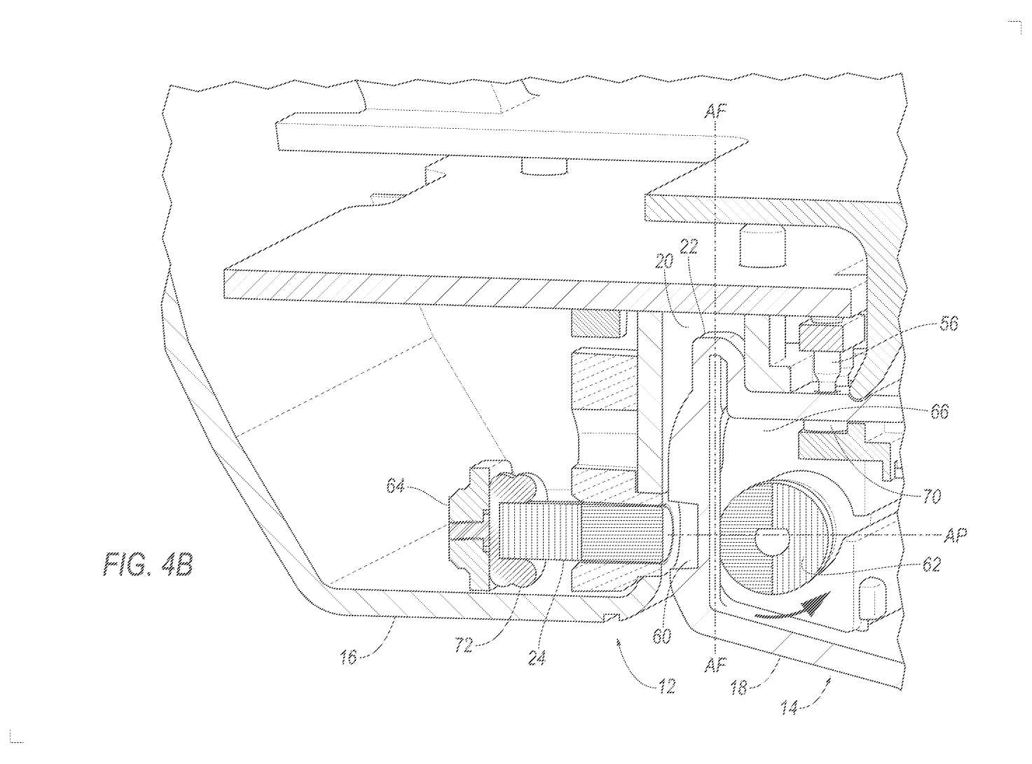

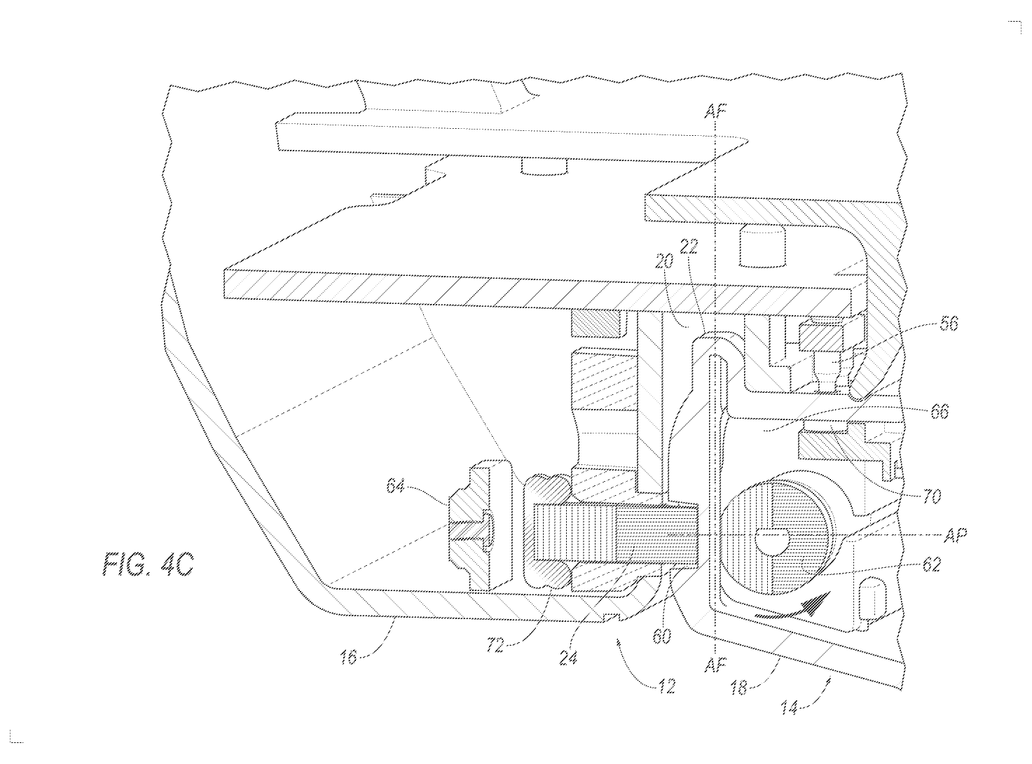

With reference to the Figures, wherein like numerals indicate like parts throughout the several views, an assembly in a vehicle 10 includes a dock 12 of the vehicle 10 and at least one portable electronic device 14. One of the dock 12 or the portable electronic device 14 includes a first casing 16, and the other of the dock 12 or the portable electronic device 14 includes a second casing 18. The first casing 16 and the second casing 18 are engageable with each other in an engaged position (FIG. 4B). One of the first casing 16 or the second casing 18 defines a notch 20 and the other of the first casing 16 or the second casing 18 includes a finger 22 extending along an axis AF into the notch 20 in the engaged position. A pin 24 is housed by the first casing 16 and is moveable relative to the first casing 16 between a retracted position (FIGS. 4A-4B) and an extended position (FIG. 4C). The pin 24 in the retracted position is disengaged from the second casing 18 allowing movement of the finger 22 along the axis AF to disengage the first casing 16 and the second casing 18. The pin 24 in the extended position is engaged with the second casing 18 preventing movement of the finger 22 along the axis AF to retain the portable electronic device 14 to the dock 12.

The portable electronic device 14 may be selectively connected to and disconnected from the dock 12. The pin 24 is in the retracted position when the portable electronic device 14 is disconnected and remains in the retracted position during docking to the dock 12. When connected to the dock 12, the pin 24 may be moved to the extended position. In the extended position, the engagement of the pin 24 with the second casing 18 and the engagement of the finger 22 with the notch 20 act against each other to lock the portable electronic device 14 to the dock 12. Specifically, during docking, the finger 22 is inserted into the notch 20, and subsequently, the pin 24 is moved to the extended position to prevent removal of the finger 22 from the notch 20.

The numerical adjectives “first,” “second,” etc., are used herein as identifiers and do not indicate order or importance. As an example, the dock 12 includes a casing and the portable electronic device 14 includes a casing, and the casings of the dock 12 and the portable electronic device 14 are identified with adjectives “first” and “second,” respectively, merely to distinguish between the casings. In other examples, the casing of the dock 12 may be referred to as the second casing and the casing of the portable electronic device 14 may be referred to as the first casing.

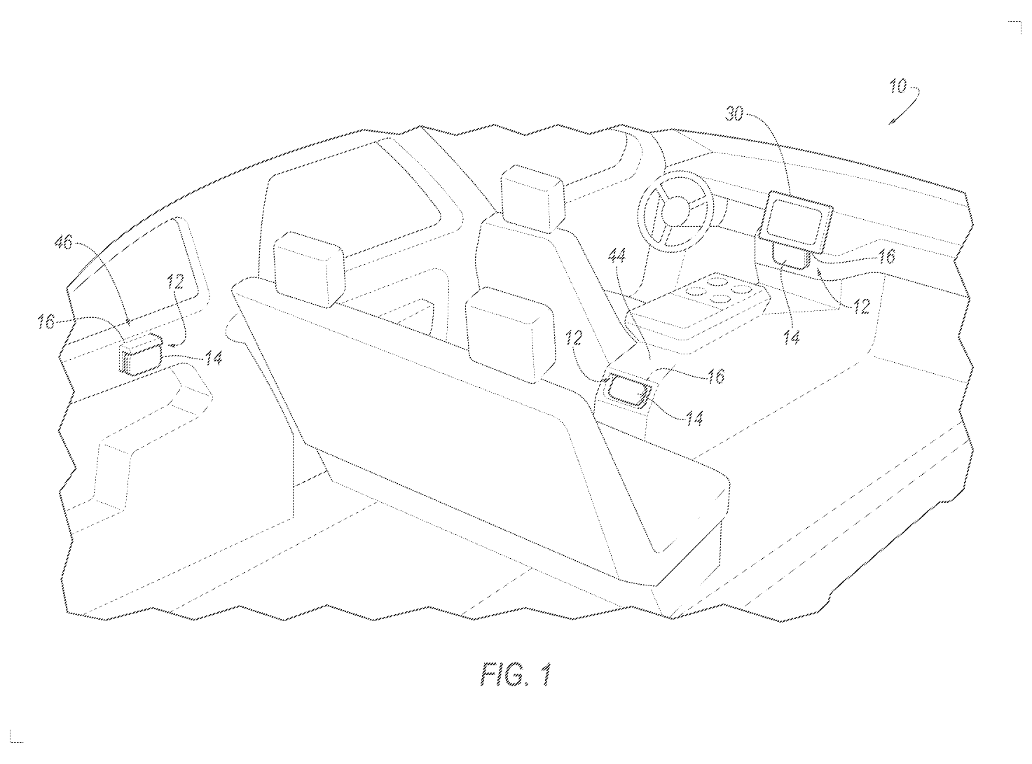

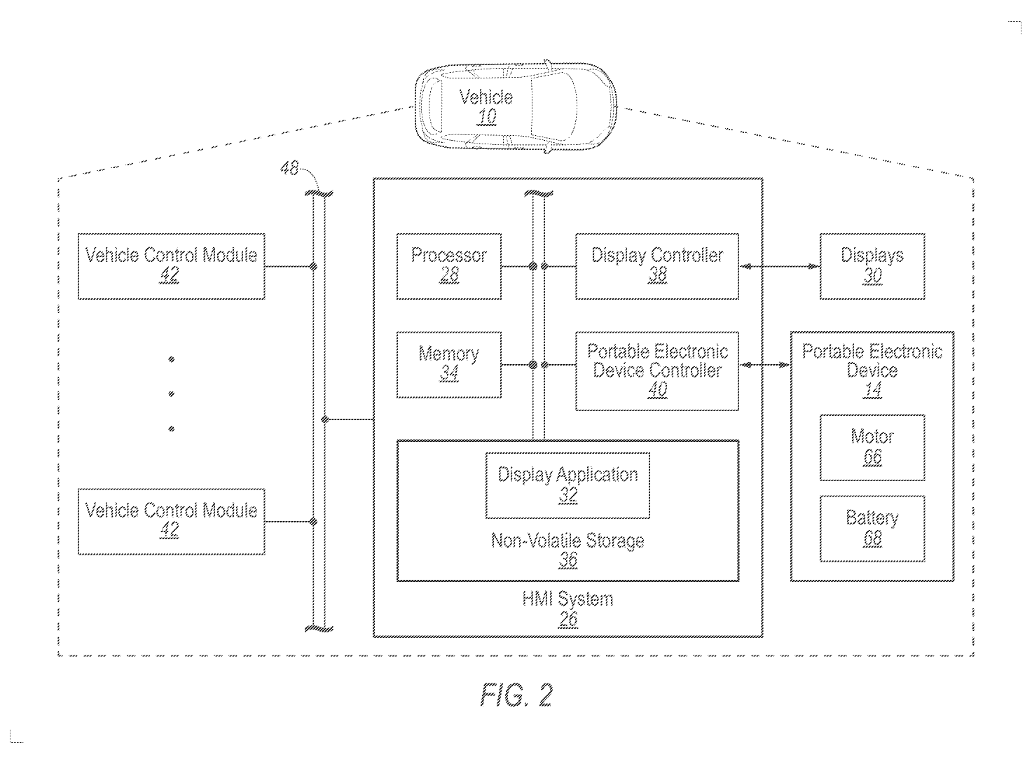

The vehicle 10 may be any suitable type of automobile, e.g., a passenger or commercial automobile such as a sedan, a coupe, a truck, a sport utility vehicle, a crossover vehicle, a van, a minivan, a taxi, a bus, etc. An example of the vehicle 10 is shown in FIG. 1 and a block diagram of an example system of the vehicle 10 and an example of the portable electronic device 14 is shown in FIG. 2.

The vehicle 10 may include one or more HMIs 26. Several examples of the HMI SYSTEM 26 are shown in FIG. 1, as described further below. One example of the HMI SYSTEM 26 is shown schematically in FIG. 2. In the example shown in FIG. 2, the HMI system 26 is connected to a display 30 and one or more portable electronic devices 14 may be connected to the HMI system 26. The HMI system 26 may include one or more processors 28 configured to perform instructions, commands, and other routines in support of the processes described herein. For instance, the HMI system 26 may be configured to execute instructions of a display application 32 loaded to a memory 34 to provide information display features. Such instructions and other data may be maintained in a non-volatile manner using a variety of types of computer-readable medium. The computer-readable medium (also referred to as a processor-readable medium or non-volatile storage 36) includes any non-transitory medium (e.g., a tangible medium) that participates in providing instructions or other data that may be read by the processor 28 of the HMI system 26. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, hypertext markup language (HTML), etc.

The HMI system 26 may be provided with various functionality to allow the occupants to interact with the vehicle 10. For example, the HMI system 26 may drive or otherwise communicate with one or more configurable displays 30 of the HMI system 26. The configurable displays 30 are configured to provide visual output to vehicle 10 occupants and receive touch input from the occupants by way of a display controller 38. The HMI system 26 may include a portable electronic device controller 40 configured to receive user input indicative of occupant-vehicle interaction from one or more portable electronic device 14 connected to the vehicle 10.

A display application 32 may be installed to the HMI system 26 and utilized to allow the vehicle 10 to provide output to the display controller 38 such that the configurable display 30 conveys the information relating to the operation of the vehicle 10 to an occupant of the vehicle 10. Input to the portable electronic device 14 may be used to control the display application 32 and/or the configurable display 30. The display application 32 may be configured to allow a user to configure the portable electronic device 14 to operate as shortcuts to various functionality of the HMI system 26. Accordingly, the user may be able to quickly access the bookmarked functions or screens using the portable electronic device 14 to provide for quick selection by the HMI system 26 on the configurable display 30. The configurable display 30 may allow the user to select which functions are to be controlled by which controls of the portable electronic device 14.

FIG. 1 is a cutaway view of an interior of the vehicle 10 in which multiple portable electronic devices 14 are connected to multiple docks 12, respectively. In some examples, more than one portable electronic device 14 may be connected to one dock 12. The HMI system 26 of the vehicle 10 may include a touch-based user interface via one or more configurable displays. The HMI system 26 may provide an ability to add, remove, and configure the portable electronic device 14 using the configurable display 30. The portable electronic device 14 may offer customizable tactile human-machine interface for various functions of the vehicle 10. The controls may be assigned to various functions such as bringing up a bookmarked display screen, or allowing for the direct configuration of settings such as utility controls (e.g., towing functions), climate controls, gig work function (e.g., rideshare), media control functions, smart home settings, vehicle 10 settings, etc.

As an example shown in FIG. 1, one or more portable electronic devices 14 may be connected to a dock 12 of an instrument panel stack, e.g., a configurable display 30 of the instrument panel stack. For example, the dock 12 may be under the instrument panel stack for easy accessibility by a vehicle occupant. As another example shown in FIG. 1, one or more portable electronic devices 14 may be connected to a dock 12 on a console bin 44, e.g., a middle console. In such an example, the portable electronic device 14 is attached to the console bin 44 for access by rear occupants, which may be useful for both retail and vehicle-as-a-service (VaaS) use cases. As another example, one or more portable electronic devices 14 may be connected to a dock 12 in a rear cargo area 46 of the vehicle 10.

With reference to FIG. 1, the HMI system 26 may be configured to communicate with other components of the vehicle 10 via one or more in-vehicle buses 48. The in-vehicle buses 48 may include one or more of a vehicle controller area network (CAN), an Ethernet network, and a media-oriented system transfer (MOST), as some non-limiting possibilities. The in-vehicle 48 buses may allow the HMI system 26 to send or receive information relevant to the HMI system 26 to and from other vehicle systems, e.g., to and from control modules 42 of the vehicle. The exemplary vehicle systems may communicate with the HMI system 26 over a main in-vehicle bus. In other examples, the HMI system 26 may be connected to more or fewer in-vehicle buses, and one or more portable electronic devices 14 or other components may be connected to the HMI system 26 via in-vehicle buses or directly without connection to an in-vehicle bus.

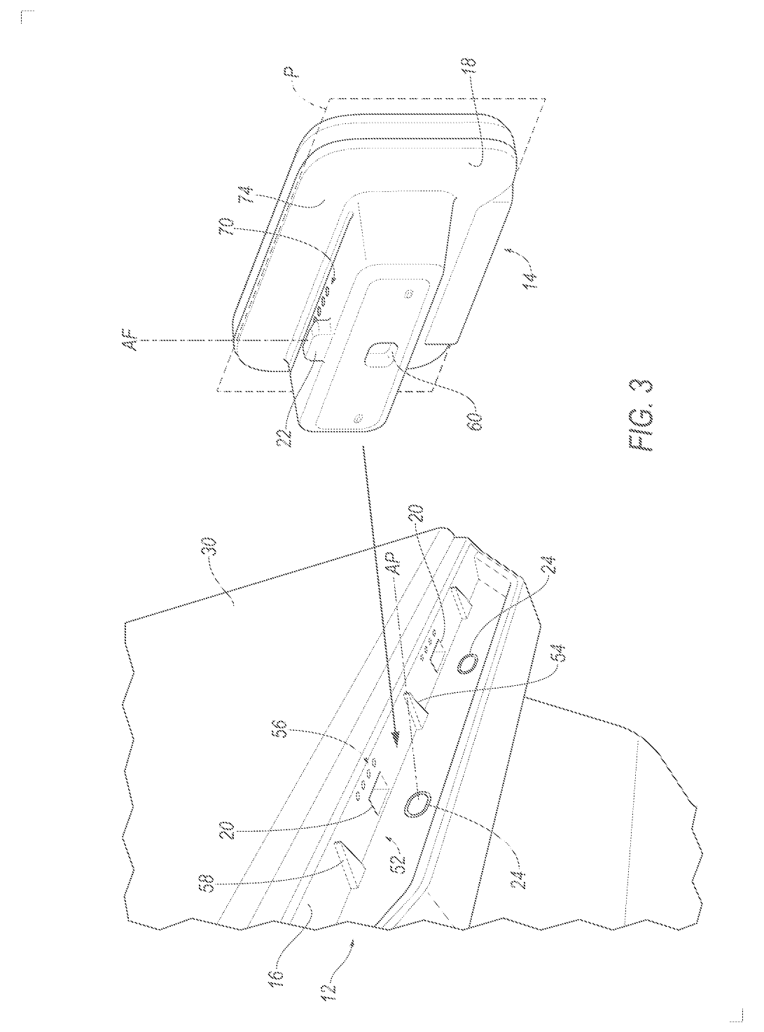

FIG. 3 is an example of a dock 12 integrated below a configurable display 30 of the vehicle 10 for connection with of the portable electronic device 14. As set forth above, the dock 12 includes a casing, referred to herein as a first casing 16. The first casing 16 houses electronic components. The casing is a non-magnetic material. In some examples, the casing may be plastic, such as polycarbonate, polypropylene, acrylonitrile butadiene styrene (ABS), etc.

As shown in the example in FIG. 3, the dock 12, and specifically the first casing 16, may define a docking port 52 for receiving a portable electronic device 14. The docking port 52 may be sized to conform with the profile of the casing of the portable electronic device 14, i.e., the second casing 18. The docking port 52 may be defined by locators 54 protruding on opposite sides of the docking port 52 to aid in the placement of the portable electronic device 14 for connection of the portable electronic device 14 to the dock 12 and for aligning terminals 56, as described below. Specifically, locators 54 may be spaced from each other defining a channel 58 therebetween to receive the second casing 18 with a sliding fit. In the example shown in FIG. 3, the first casing 16 includes multiple docking ports 52. In such an example, the docking ports 52 may be identical to interchangeably receive any one of interchangeable portable electronic devices 14. In the example shown in FIG. 3, the portable electronic device 14 is disposed below the dock 12 when connected to the dock 12. In such an example, the locators 54 extend downwardly from a surface of the dock 12.

The dock 12 may include an electronic terminal 56 for transmitting power and/or data. In the example shown in the Figures, the electronic terminal 56 is exposed through the first casing 16. As an example, the example in FIG. 3 includes four pins. In such an example, the four pins may be 5V power, 48V power, a serial data pin 24, and ground. In other examples, the electronic terminal 56 may include any suitable type and number of ports, pins, plugs, etc. The electronic terminal 56 of the dock 12 is aligned with an electronic terminal 70 of the portable electronic device 14 when the portable electronic device 14 is connected to the dock 12.

The portable electronic device 14 includes a casing, referred to as a second casing 18. The second casing 18 houses electronic components of the portable electronic device 14. The casing is a non-magnetic material. In some examples, the casing may be plastic, such as polycarbonate, polypropylene, acrylonitrile butadiene styrene (ABS), etc.

The portable electronic device 14 may include a display and/or an input interface such as touch screens, buttons, knobs, or other physical controls to receive input from a human occupant of the vehicle 10. The portable electronic device 14 may provide input to the HMI system 26 and/or may receive input from the HMI system 26.

The portable electronic device 14 may include an electronic terminal 70 for transmitting power and/or data. In the example shown in the Figures, the electronic terminal 70 is exposed through the second casing 18. As an example, the example in FIG. 3 includes four pins. In such an example, the four pins may be 5V power, 48V power, a serial data pin 24, and ground. In other examples, the electronic terminal 70 may include any suitable type and number of ports, pins, plugs, etc. As set forth above, the electronic terminal 70 of the portable electronic device 14 is aligned with the electronic terminal 56 of the dock 12 when the portable electronic device 14 is connected to the dock 12.

The portable electronic device 14 is releasably engageable with the dock 12. In examples including more than one dock 12 in the interior of the vehicle 10, the portable electronic device 14 may be releasably engageable with any one of the docks 12. In such examples, any one of interchangeable portable electronic devices 14 may be interchangeably connected to any one of the docks 12 and may be interchangeably connected with any one of the docking ports in examples that include multiple docking portions on a single dock 12.

The first casing 16 and the second casing 18 are engageable with each other in the engaged position. Specifically, in the engaged position, the finger 22 is in the notch 20 and the engagement of the pin 24 retains the finger 22 in the notch 20. Specifically, the pin 24 prevents removal of the finger 22 from the notch 20. As set forth below, the pin 24 engages the first casing 16 and the second casing 18 to prevent relative movement of the casings to release the finger 22 from the notch 20. To disengage the first casing 16 and the second casing 18, the pin 24 is moved to the retracted position before the finger 22 is releasable from the notch 20.

As set forth above, the adjectives “first” and “second” are used herein merely identifiers. The finger 22 may be on either the casing of the dock 12 or the casing of the portable electronic device 14, and the notch 20 is on the other of the casing of the dock 12 or the casing of the portable electronic device 14. The pin 24 may be supported by either the casing of the dock 12 or the casing of the portable electronic device 14 in the retracted position, and in the extended position the pin 24 engages the other of the casing of the dock 12 or the casing of the portable electronic device 14. Merely as one example, in the example shown in the Figures, the notch 20 is on the casing of the dock 12, the finger 22 is on the casing of the portable electronic device 14, and the pin 24 is supported by the casing of the dock 12 in the retracted position and engages the casing of the portable electronic device 14 in the extended position. In some examples, the notch 20 may be on the casing of the portable electronic device 14 and the finger 22 may be on the casing of the dock 12. In some examples, the pin 24 is supported by the casing of the portable electronic device 14 in the retracted position and engages the casing of the dock 12 in the extended position.

The finger 22 extends along the axis AF into the notch 20 in the engaged position. Specifically, in the example shown in the Figures, the casing includes a body 74 and the finger 22 extends from the body 74 on the axis AF. The pin 24 in the engaged position prevents relative movement of the casings along the axis AF, thus locking the finger 22 in the notch 20. The finger 22 and the notch 20 are configured to (i.e., sized, shaped, and positioned to) restrict movement of the finger 22 to translation along the axis AF when the finger 22 is in the notch 20. In other words, the notch 20 prevents movement of the finger 22 other than along the axis AF when the finger 22 is in the notch 20. In the example shown in the Figures, the notch 20 is recessed from a surface of the dock 24 along a notch axis AN. In examples in which the finger 22 is on the dock 12 and the notch 20 is on the portable electronic device 14, the notch 20 is recessed from the body 74 along the axis AN.

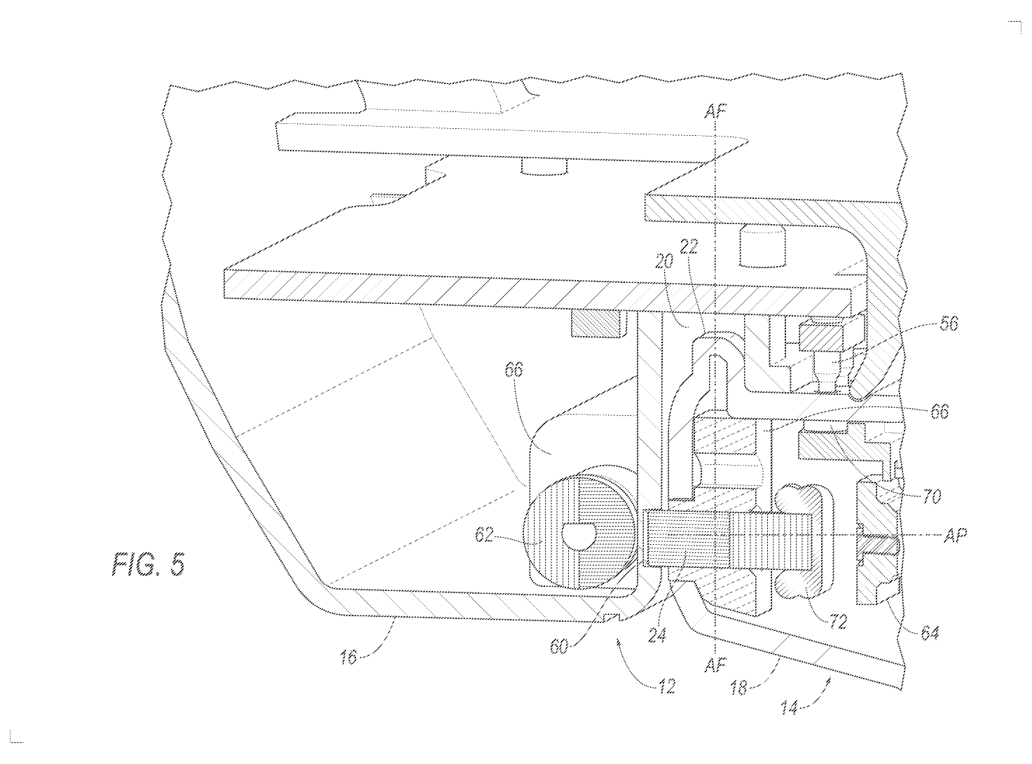

The pin 24 is housed by either the first casing 16 or the second casing 18. In the example shown in FIGS. 3-4C, the pin 24 is housed in the first casing 16. In the example shown in FIG. 5, the pin 24 is housed in the second casing 18. With reference to the example shown in FIGS. 3-4C, the pin 24 is moveable relative to the first casing 16 between a retracted position disengaged from the second casing 18 and an extended position engaged with the second casing 18 preventing movement of the finger 22 along the axis AF.

With continued reference to FIGS. 3-4C, the pin 24 is supported by the first casing 16, i.e., the weight of the pin 24 is borne by the first casing 16 in the retracted position. The pin 24 is slidable relative to the first casing 16 between the retracted position and the extended position and is retained in engagement with the first casing 16 in both the retracted position and the extended position. The pin 24 is slidable relative to the first casing 16 along a second axis AP.

In the example shown in FIGS. 3-4C, the second casing 18 includes a recess 60 that receives the pin 24 in the extended position. In such an example, the pin 24 in the extended position protrudes from the first casing 16 and engages the second casing 18 in the recess 60. The recess 60 may be configured to (i.e., sized, shaped, and positioned) to restrict movement of the finger 22 to translation along the second axis AP when the pin 24 is in the extended position in the recess 60. In other words, the recess 60 prevents movement of the pin 24 other than along the second axis AP when the pin 24 is in the recess 60. In examples in which the pin 24 is supported by the second casing 18 in the retracted position, the first casing 16 may define the recess 60 to receive the pin 24. In the example shown in FIG. 5, the first casing 16 includes the recess 60.

The finger 22 in the notch 20 and the pin 24 engaged with second casing 18, e.g., in the recess 60, engage the first casing 16 and the second casing 18 in counteracting directions to lock the first casing 16 and the second casing 18 to each other. To connect the portable electronic device 14, the finger 22 is engaged with the notch 20 and then the pin 24 is moved to the extended position to lock the finger 22 in the notch 20. The engagement of the pin 24 with the second casing 18 prevents removal of the extension from the notch 20, and the engagement of the finger 22 with the notch 20 retains the pin 24 in engagement with the second casing 18, e.g., with the recess 60.

The axis AF of the finger 22 is in a plane P. The portable electronic device 14 may be elongated in the plane P. Specifically, second casing 18 may be elongated in the plane P. The pin 24 moves along the second axis AP transverse to the plane P between the extended position and the retracted position. In some examples, including the example shown in the Figures, the second axis AP is perpendicular to the plane P. In some examples, the axis AP of the pin 24 is transverse to the axis AF of the finger 22. Specifically, in some examples, including the example shown in the Figures, the axis AP is perpendicular to the axis AF. The axis AF of the finger 22 and the axis AN of the notch 20, extend along the plane P. In some examples, the axes AF and AN are parallel to the plane P. In such examples, the axes AF and AN may be spaced from the plane P or on the plane P.

In some examples, including the example shown in the Figures, the pin 24 is magnetically moved between the retracted position and the extended position. The pin 24 is ferromagnetic. In the example shown in the Figures, the pin 24 is a magnet (schematically identified with different cross hatching identifying different magnetic poles of the pin 24 in the cross sections of FIGS. 4A-5).

The assembly includes a toggle magnet 62 switchable between a first state (FIG. 4B) in which a magnetic field of the toggle magnet 62 positions the pin 24 in the retracted position and a second state (FIG. 4C) in which the pin 24 is in the extended position. The toggle magnet 62 toggles between the first state and the second state. In some examples, including the example shown in the Figures, the toggle magnet 62 repels the pin 24 in the first state and attracts the pin 24 in the second state. In other words, in such examples, when the toggle magnet 62 is in the first state, the pin 24 is in a magnetic field of the toggle magnet 62 and the toggle magnet 62 applies an repulsive force to the pin 24, and when the toggle magnet 62 is in the second state, the pin 24 is in the magnetic field of the toggle magnet 62 and the toggle magnet 62 applies an attractive force to the pin 24. Specifically, in the example shown in the Figures, the toggle magnet 62 may be physically rotated between the first state and the second state, i.e., to toggle the positions of the poles of the toggle magnet 62. In FIGS. 4B-5, the toggle magnet 62 is in cross section and FIGS. 4B-5 schematically identify different magnetic poles of the pin 24 with different cross hatching. In other examples, the toggle magnet 62 may be a solenoid that is powered in the first state and unpowered in the second state, a switching magnet, a magnet that is moved in translation toward and away from the pin 24, etc.

In the example shown in FIGS. 3-4C, the toggle magnet 62 is housed by the second casing 18. In such an example, the attractive force of the toggle magnet 62 in the second state moves the pin 24 to the extended position and the repulsive force of the toggle magnet 62 in the first state moves the pin 24 to the retracted position. In examples in which the pin 24 is a magnet, such as in the example in the Figures, opposite poles of the toggle magnet 62 and the pin 24 (i.e., the north pole of one and the south pole of the other) are within the magnetic field of each other when the toggle magnet 62 is in the second state and the pin 24 is in the extended position, and the same poles of the toggle magnet 62 and the pin 24 are within the magnetic field of each other when the toggle magnet 62 is in the first state and the pin 24 is in the retracted position. In the example shown in FIG. 5, the toggle magnet 62 is housed by the first casing 16. The toggle magnet 62 is position in the first casing 16 so that, in the first state, one pole of the magnetic field faces the recess, and a second state, the other pole of the magnetic field faces the recess. Accordingly, the toggle magnet 62 is configured to apply a repulsive force to the pin 24 in the first state and to apply an attractive force to the pin 24 in the second state.

In some examples in which the pin 24 is a magnet, the casing that houses the pin 24, e.g., the first casing 16 in the example in FIGS. 3-4C and the second casing 18 in the example in FIG. 5, houses a ferromagnetic anchor 64 in the magnetic field of the pin 24 in the retracted position. The ferromagnetic anchor 64 may be, for example, steel. When the pin 24 is in the retracted position, the magnetic attraction between the pin 24 and the ferromagnetic anchor 64 retains the pin 24 in the retracted position absent other forces that overcome the magnetic attraction. In such examples, the attractive force of the toggle magnet 62 is greater than the attractive force of the pin 24 to the ferromagnetic anchor 64 in the retracted position. Accordingly, when the toggle magnet 62 is in the second state, the magnetic attraction of the toggle magnet 62 overcomes the magnetic attraction of the pin 24 to the ferromagnetic anchor 64 to move the pin 24 to the extended position. In the examples shown in the Figures, the pin 24 is between the ferromagnetic anchor 64 and the toggle magnet 62 so that the magnetic attraction of the pin 24 to the ferromagnetic anchor 64 is in an opposite direction of the magnetic attraction of the pin 24 the toggle magnet 62.

In the example shown in the Figures, a cap 72 is on the pin 24 between the pin 24 and the ferromagnetic anchor 64. In such examples, the cap 72 may retain the pin 24 to the respective housing (i.e., the first housing 16 in FIGS. 3-4C and the second housing 18 in FIG. 5) in the extended position. The cap 72 may be ferromagnetic material or may be a material that does not interfere with the magnetic force of the pin 24, e.g., plastic.

As set forth above, in the example shown in the Figures, the toggle magnet 62 may be rotated between the first state and the second state. For example, the assembly may include a motor 66 that rotates the toggle magnet 62 between the first state and the second state. The motor 66 may rotate the toggle magnet 62 180 degrees between the first state and the second state. In such an example, the positions of the north pole and the south pole of the toggle magnet 62 are swapped, as discussed above. The motor 66 may be, for example, a DC motor or any other suitable type of motor. In the example shown in the Figures, the toggle magnet 62 and the motor 66 are housed by the second casing 18. In some examples, the electronics in the portable electronic device 14, including the motor 66, may be powered by electricity from the vehicle 10 through the electronic terminals. In some examples, in addition to or in the alternative to power through the electronic terminals, the portable electronic device 14 may include a battery 68 that powers electronics of the portable electronic device 14, including the motor 66. In such examples, the battery 68 may be rechargeable with power from the vehicle 10 through the electronic terminals.

The movement of the pin 24 is between the retracted position and the extended position, e.g., operation of the motor 66 to toggle the toggle magnet 62, may be controlled by a human operator of the vehicle 10 and/or may be controlled by the vehicle 10 based on operation of the vehicle 10. As one example, the pin 24 may be moved to the extended position in response to input by the human operator of the vehicle 10 to lock the portable electronic device 14 to the dock 12, and the pin 24 may be moved to the retracted position in response to input by the human operator of the vehicle 10 to unlock the portable electronic device 14 from the dock 12. Input to lock or unlock may be entered by the human operator through an interface on the personal mobility device and/or an interface on the vehicle 10 (e.g., the configurable display) such as buttons, knobs, touchscreen, etc. As another example, the vehicle 10, e.g., the HMI system 26, may automatically move the pin 24 to the extended position in response to movement of the vehicle 10, e.g., placement of the vehicle 10 in a Drive setting, and may automatically move the pin 24 to the retracted position in response to the vehicle stopping, e.g., placement of the vehicle 10 in a Park setting.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. An assembly comprising:
a dock; and
a portable electronic device;
one of the dock or the portable electronic device including a first casing, and the other of the dock or the portable electronic device including a second casing, the first casing and the second casing being engageable with each other in an engaged position;
one of the first casing or the second casing defining a notch and the other of the first casing or the second casing including a finger extending along an axis into the notch in the engaged position; and
a pin housed by the first casing and moveable relative to the first casing between a retracted position disengaged from the second casing and an extended position engaged with the second casing preventing movement of the finger along the axis.

2. The assembly of claim 1, wherein the pin is ferromagnetic, and further comprising a toggle magnet switchable between a first state in which a magnetic field of the toggle magnet positions the pin in the extended position and a second state in which the pin is in the retracted position.

3. The assembly of claim 1, wherein the pin is ferromagnetic, and further comprising a toggle magnet switchable between a first state in which the pin is in a magnetic field of the toggle magnet and the toggle magnet applies a repulsive force to the pin and a second state in which the pin is in the magnetic field of the toggle magnet and the toggle magnet applies an attractive force to the pin.

4. The assembly of claim 3, wherein the toggle magnet is housed by the second casing.

5. The assembly of claim 4, wherein the attractive force of the toggle magnet in the second state moves the pin to the extended position and the repulsive force of the toggle magnet in the first state moves the pin to the retracted position.

6. The assembly of claim 3, wherein the pin is a magnet.

7. The assembly of claim 6, further comprising a ferromagnetic anchor in the first casing and in a magnetic field of the pin in the retracted position.

8. The assembly of claim 7, wherein the pin is between the ferromagnetic anchor and the toggle magnet.

9. The assembly of claim 7, wherein the attractive force of the toggle magnet is greater than an attractive force of the pin to the ferromagnetic anchor in the retracted position.

10. The assembly of claim 3, further comprising a motor that rotates the toggle magnet between the first state and the second state.

11. The assembly of claim 10, wherein the toggle magnet and the motor are housed by the second casing.

12. The assembly of claim 1, wherein the second casing includes a recess that receives the pin in the extended position.

13. The assembly of claim 1, wherein axis of the finger is in a plane and the pin moves along a second axis transverse to the plane between the extended position and the retracted position.

14. The assembly of claim 13, wherein the second axis is perpendicular to the plane.

15. The assembly of claim 13, wherein the portable electronic device is elongated in the plane.

16. The assembly of claim 13, wherein the second casing includes a recess that receives the pin in the extended position, the recess being on the second axis.

17. The assembly of claim 13, wherein the pin is ferromagnetic, and further comprising a toggle magnet switchable between a first state in which the pin is in a magnetic field of the toggle magnet and the toggle magnet applies a repulsive force to the pin and a second state in which the pin is in the magnetic field of the toggle magnet and the toggle magnet applies an attractive force to the pin.

18. The assembly of claim 1, wherein the first casing supports electronic terminals in contact with electronic terminals supported by the second casing when the first casing and the second casing are in the engaged position.

19. A portable electronic device comprising:
a casing configured to be engaged with a dock of a vehicle;
the casing having a body elongated in a plane;
the casing including a finger extending from or a notch recessed into the body along a first axis along the plane;
the casing having a recess recessed into the body along a second axis transverse to the plane; and
a toggle magnet having a magnetic field, the recess being in the magnetic field;
the toggle magnet being switchable between a first state in which one pole of the magnetic field faces the recess and a second state in which the other pole of the magnetic field faces the recess.

20. The portable electronic device of claim 19, further comprising a motor that rotates the toggle magnet between the first state and the second state.
